(19) United States
(12) Patent Application Publication
(10) Pub. No.: US 2012/0211976 A1
(43) Pub. Date: Aug. 23, 2012

(54) PIPE ELEMENT FAST CONNECTION STRUCTURE

(76) Inventor: Xiaohong Cui, Suzhou (CN)

(21) Appl. No.: 13/264,074

(22) PCT Filed: Jul. 22, 2010
(86) PCT No.: PCT/CN10/75405

§ 371 Date: Nov. 15, 2011

(30) Foreign Application Priority Data
Aug. 18, 2009 (CN) 200910034025.2

(51) Int. Cl. F16L 37/12

(52) U.S. Cl. 285/305

(57) ABSTRACT

A pipe element fast connection structure is disclosed, in which an inner pipe element is inserted in an outer pipe element and two pipe elements are fixed each other; the connection element comprises a sleeve pipe and an annular spring element with an open end, and the open end of the spring element bends inward and forms a pair of plug; the sleeve pipe is provided fixedly around the up end of the inner pipe element, and both of the inner pipe element and the sleeve pipe are inserted in the outer pipe; a pair of through holes are provided on the outer pipe, and at least a concave groove is provided on the side wall of the sleeve pipe, corresponding to the through holes; the pair of plugs of the spring element plug into a pair of through holes of the outer pipe, and when the spring element is turned around the through holes of the outer pipe, at least two steady state which form two working positions can be formed: a locking working position and an unlocking working position. The combined structure of the sleeve pipe and the spring element of the invention realize the fast locking and fast disassemble between pipes, and the structure is convenience, safe and reliable in use.

### TECHNICAL FIELD

This invention relates to a connection structure of metal pipe, and more particularly to a pipe element fast connection structure, which may achieve the goal of fast locking and unlocking of pipes.

### BACKGROUND OF THE INVENTION

A connection structure is a necessary component in the assembly process of pipe element, which is used to connect two pipes. Existing connection structure mainly include welded and threaded connection structure, however, for some situation which need fast locking and unlocking of pipes, such as the folding handlebar of the folding bicycle, it needs a pipe element fast connection structure.

There are some existing pipe element connection structure, such as Chinese utility model patent CN2937598Y which disclosed a pipe fixed structure, including two symmetrical curved block which from a circular surface inside the two curved blocks, one end of the circular surface extends outward and forms a junction element, and a hinge joint element is provided on the other end, a clamping positioning element is provided irruptive in the junction element; a join element is also provided which hinges with the hinge joint element as a detachable structure, and forming a hole in the circular surface of the two curved blocks, and a number of adjust holes are provided interval on the surface of the joint element which connecting the two curved blocks; said clamping positioning element is an alien screw and a coordinate screw cap which transverse through the junction element of the two curved blocks.

When using, an inner pipe element is inserted in an outer pipe element, and the two curved blocks are set around the combination part of the two pipe element, and then locking the junction element and hinge joint element, when unlocking, releasing the clamping positioning element of the junction element, and then pulling out the inner pipe element. Adjust holes are provided on the surface of the joint element, so the aperture of the hole of the pipe fixed structure can be changed arbitrarily, in order to apply the different aperture of pipes.

However, the two curved blocks of said pipe fixed structure are connected by the alien screw and the coordinate screw cap, so it's not convenient when locking and unlocking, it can't achieve the goal of fast locking and unlocking of pipes.

### SUMMARY OF THE INVENTION

The object of the present invention is to provide a pipe element fast connection structure, in order to achieve the goal of fast locking and unlocking of pipes.

This object is achieved according to the technical solution described below:

A pipe element fast connection structure, in which an inner pipe element is inserted in an outer pipe element and two pipe elements are fixed each other by a connector element, said connector element comprises an annular spring element with an open end, and the open end of the spring element bends inward and forms a pair of plugs; a pair of through holes are provided on said outer pipe element, and at least one hole is provided on the inner pipe element which is inserted in the outer pipe element, corresponding to said through holes; a pair of plugs of said spring element plug into a pair of through holes of said outer pipe element, and when the spring element is turned around the through holes of the outer pipe element, at least two steady state which form two working positions can be formed:

(1) locking working position: at least one plug of said spring element drill through the through hole of said outer pipe element and clamp in the hole of the inner pipe element; the distance of the two plugs of the spring element is less than the outer diameter of the inner pipe element, corresponding to the hole;

(2) unlocking working position: when the inner part of the annular spring element and outer part of the outer pipe element are interfered, the spring element is softened, and the plug is divorced from the hole; the distance of the two plugs of the spring element is more than the outer diameter of the inner pipe element, corresponding to the hole, and less than the outer diameter of the outer pipe element, corresponding to the through holes.

Another corresponding technical solution is described below:

A pipe element fast connection structure, in which an inner pipe element is inserted in an outer pipe element and two pipe elements are fixed each other by a connector element, said connection element comprises a sleeve pipe and an annular spring element with an open end, and the open end of the spring element bends inward and forms a pair of plugs; said sleeve pipe is provided fixedly around the up end of the inner pipe element, and both the inner pipe element and the sleeve pipe are inserted in the outer pipe element; a pair of through holes are provided on the outer pipe element, and at least one concave groove is provided on the side wall of the sleeve pipe, corresponding to the through holes; a pair of plugs of said spring element plug into a pair of through holes of said outer pipe element, and when the spring element is turned around the through holes of the outer pipe element, at least two steady state which form two working positions can be formed:

(1) locking working position: at least one plug of said spring element drill through the through hole of said outer pipe element and clamp in the concave groove of the sleeve pipe; the distance of the two plugs of the spring element is less than the outer diameter of the sleeve pipe, corresponding to the concave groove;

(2) unlocking working position: when the inner part of the annular spring element and outer part of the outer pipe element are interfered, the spring element is softened, and the plug is divorced from the concave groove; the distance of the two plugs of the spring element is more than the outer diameter of the sleeve pipe, corresponding to the concave groove, and less than the outer diameter of the outer pipe element, corresponding to the through holes.

Above, the connection structure of the outer pipe element and inner pipe element is as follows: the sleeve pipe is provided fixedly around the up end of the inner pipe element, and then both the inner pipe element and the sleeve pipe are inserted in the outer pipe element, and the outer pipe element and inner pipe element are locked by the spring element. The pipe element fast connection structure of the present invention is the same with the connection of two pipes, and without limiting the installation position of the pipes, such as the connection of level pipes is also applicable. The shape of the spring element can be different; the main innovation is to force the spring element being softened and the plug divorcing from the hole when the spring element is pulling up and the inner part of the annular spring element and outer part of the outer pipe element are interfered, and to facilitate the separation of pipes.

In above technical solution, a waist structure is provided on said spring element, which forces the plug divorcing from the concave groove when the inner part of the annular spring element and outer part of the outer pipe element are interfered and the spring element is softened, and which forces the spring element into the position of said unlocking working position. Because the waist structure is provided, so the two working position can be formed: the first position is locking working position, two plugs of the spring element drill through the through holes and clamp in the concave grooves, forcing the inner pipe element and outer pipe element being fixed relatively. The second position is unlocking working position, the spring element is pulling up and clamps on the outer pipe element, the two plugs open outwards and divorce from the holes, and then the outer pipe element can be pulled out.

A pair of through holes are provided on the outer pipe element, and at least one hole or concave groove is provided on the inner pipe element or sleeve pipe, corresponding to said through holes, and two holes or concave grooves are preferred, the outer pipe element and inner pipe element can be fixed better when the two plugs of the spring element are plugging into the holes or concave grooves.

Another corresponding technical solution is described below: a plastic ball is provided on said spring element or the outer pipe element, which forms a block point, forcing the plug divorcing from the concave groove when the inner part of the annular spring element and outer part of the outer pipe element are interfered and the spring element is softened, and forcing the spring element into the position of said unlocking working position. Such structure is similar with said waist structure. The locking working position and unlocking working position are formed by the block point. Of course, the similar structure can also be used to achieve above object, for example, the plastic ball or the step structure is provided directly on the outer pipe element to form the block point.

In above technical solution, at least one protuberant block is provided on the inner wall of said sleeve pipe, and a coordinate groove is provided on the outer wall of the inner pipe element; a cap is provided on the top end of the inner pipe element, and said sleeve pipe is provided fixedly around the inner pipe element by the cap. Said protuberant block and the coordinate groove prevent relative rotation between the sleeve pipe and inner pipe element, and the sleeve pipe is provided fixedly around the inner pipe element by the cap and prevents axial displacement of the sleeve pipe and inner pipe element, so such structure together forces the sleeve pipe fixing around the up end of the inner pipe element; and at the same time, such structure can provide an impact pressure to the bowl bearing of the bicycle head.

The preferred technical solution, said sleeve pipe is consisted of an upper taper piece [symbol] sleeve and lower tapper piece, a coordinate taper is provided on the end of said outer pipe element. The sleeve pipe is designed as a split structure, which is not only convenience for the machine, but also convenience to disassemble or assemble when using; and the sleeve pipe which is designed as a taper pipe can also improve the bonding strength of the inner pipe element and outer pipe element. Of course, the sleeve pipe can also be a taper pipe which is the integrated structure or an ordinary straight sleeve.

The preferred technical solution, an outside sleeve is provided around said spring element. The outside sleeve can be produced by plastic or rubber, and has self lubricating effect. It can also prevent rubbing scratch because of the direct rub of the spring element and pipe element when using.

In above technical solution, a connector is provided which connects with the spring element in one end, and connects with a prizing piece in the other end, said prizing piece connects rotary with a C-shaped ring which is fixed between the inner pipe element and outer pipe element. The prizing piece is easy to use by women and children, and it's easy to disassemble the inner pipe element and outer pipe element; the connector and C-shape ring are used to connect the inner pipe element and outer pipe element, and prevent lost when the two pipes are disassembled.

In above technical solution, two concave grooves are provide on the side wall of the sleeve pipe, two plugs of said spring element drill through the through hole and clamp in the concave grooves respectively.

The preferred technical solution, at least one concave groove of said two concave grooves is cuneal, and the corresponding plug of the spring element is coordinate cuneal plug. This structure is convenience to use the spring element; and also can force the outer pipe element fixing closely around the inner pipe element by a downwards pressure to the outer pipe element when the sleeve pipe and outer pipe element have a taper.

The working principle of the present invention is as follows:

When assembling, the sleeve pipe is provided fixedly around the up end of the inner pipe element first, then both the inner pipe element and the sleeve pipe are inserted in the outer pipe element, the two pipes are fixed by the spring element. This time the spring element is in the locking working position. When disassembling, the spring element is pulling up and clamps on the outer pipe element, the two plugs open outwards and divorce from the holes, and then the outer pipe element can be pulled out. This time the spring element is in the unlocking working position.

With using of the above technical solution, this invention has the following effects compared with the background technologies:

1. In this invention, the combination structure of the sleeve and the spring element is used to achieve the goal of fast locking and unlocking of pipes. And this structure is easy to use and safe and reliable. The connection element is less weight and free to motion, It has real significance.

2. The pipe element fast connection structure of this invention is easy to manufacture, and has a good application prospect.

### BRIEF DESCRIPTION OF THE DRAWINGS

FIG. 1 illustrates the schematic diagram of assemblage in Example 1.

FIG. 2 illustrates the local section diagram of FIG. 1.

FIG. 3 illustrates the schematic diagram of connection of the spring element in Example 1.

FIG. 4 illustrates the planform diagram of the upper taper piece in Example 1.

FIG. 5 illustrates the main section diagram of FIG. 4.

FIG. 6 illustrates the planform diagram of the lower taper piece in Example 1.

FIG. 7 illustrates the main section diagram of FIG. 6.

FIG. 8 illustrates the planform diagram of the sleeve pipe in Example 1.

FIG. 9 illustrates the main section diagram of FIG. 8.

FIG. 10 illustrates the side elevation diagram of the outer pipe element in Example 1.

FIG. 11 illustrates the schematic diagram of assemblage in Example 2.

FIG. 12 illustrates the schematic diagram of connection of the spring element in Example 2.

In which: 1 [symbol] sleeve pipe; 2 [symbol] spring element; 3 [symbol] inner pipe element; 4 [symbol] through hole; 5 [symbol] plug; 6 [symbol] outer pipe element; 7 [symbol] protuberant block; 8 [symbol] cap; 9 [symbol] upper taper piece; 10 [symbol] sleeve; 11 [symbol] lower taper piece; 12 [symbol] outside sleeve; 13 [symbol] connector; 14 [symbol] prizing piece; 15 [symbol] C-shaped ring.

### DESCRIPTION OF EXAMPLE EMBODIMENTS

This invention will be best understood with reference to the figures and following description of example embodiments:

### Example 1

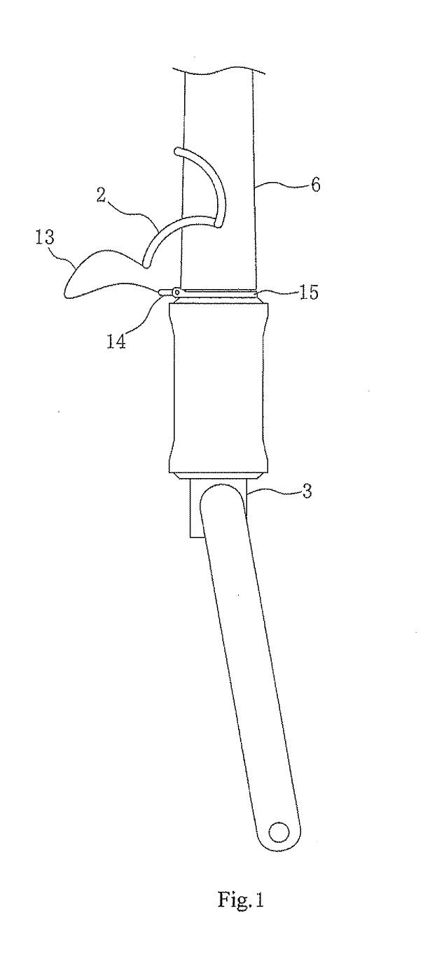

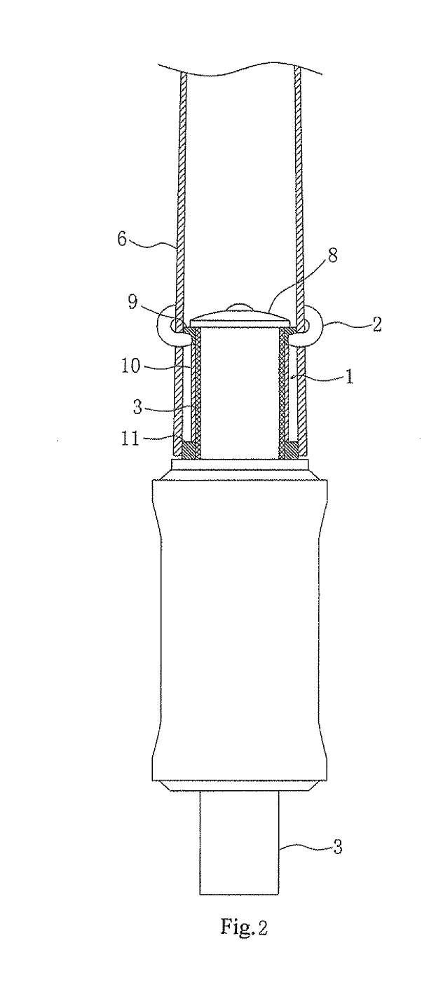

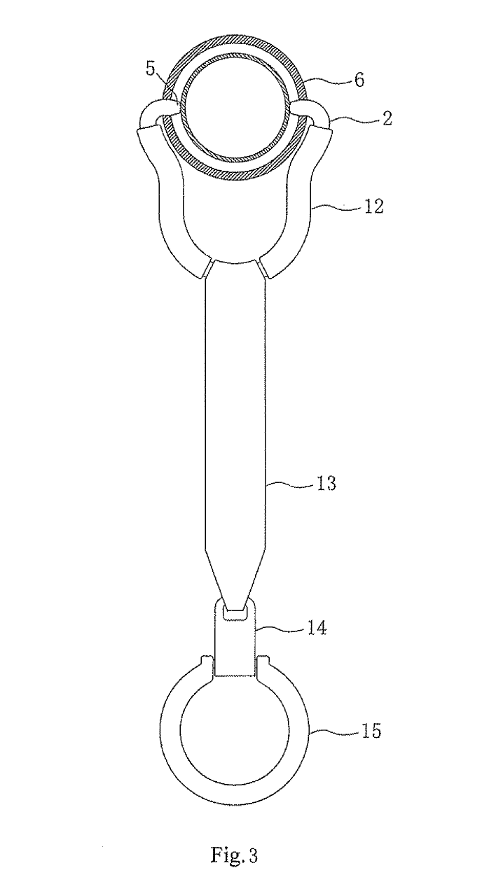

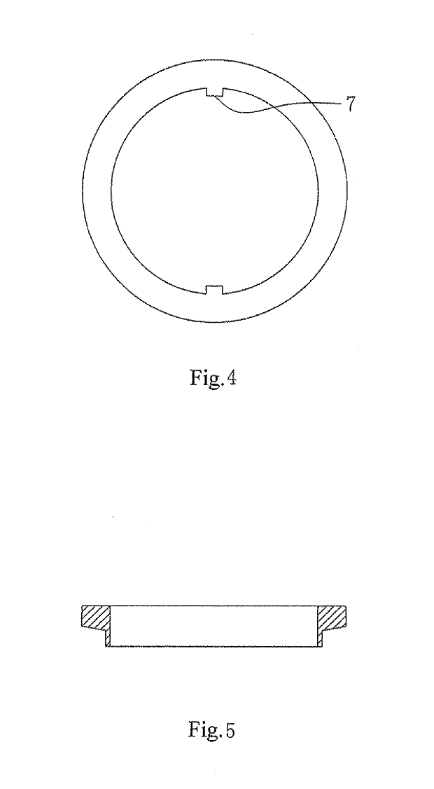

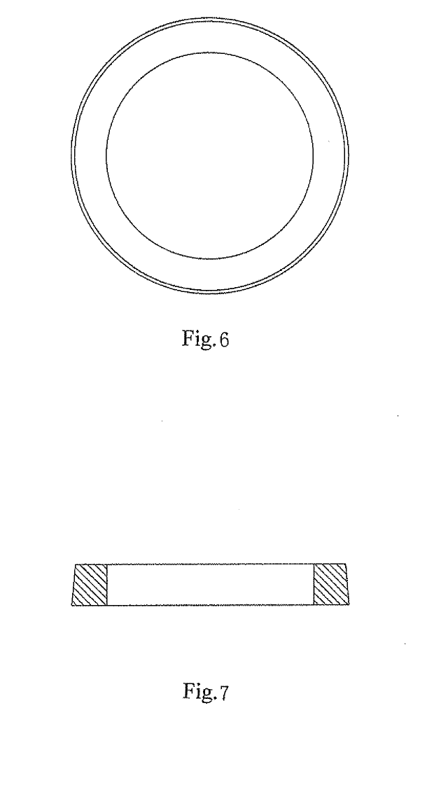

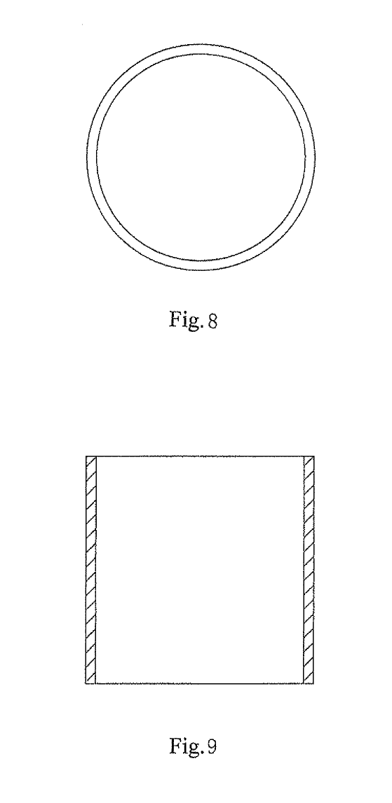

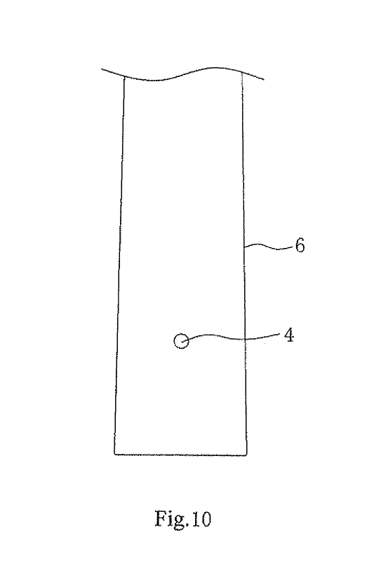

FIG. 1˜10 illustrate a pipe element fast connection structure, in which an inner pipe element is inserted in an outer pipe element and two pipe elements are fixed each other by a connector element, said connection element comprises a sleeve pipe 1 and an annular spring element 2 with an open end, and the open end of the spring element 2 bends inward and forms a pair of plugs 5; said sleeve pipe 1 is provided fixedly around the up end of the inner pipe element 3, and both the inner pipe element 3 and the sleeve pipe 1 are inserted in the outer pipe element 6; a pair of through holes 4 are provided on the outer pipe element 6, and at least one concave groove is provided on the side wall of the sleeve pipe 1, corresponding to the through holes 4; the pair of plugs 5 of said spring element 2 plug into a pair of through holes 4 of said outer pipe element 6, and when the spring element 2 is turned around the through holes 4 of the outer pipe element 6, at least two steady state which form two working positions can be formed:

(1) locking working position: at least one plug 5 of said spring element 2 drill through the through hole of said outer pipe element and clamp in the concave groove of the sleeve pipe; the distance of the two plugs of the spring element is less than the outer diameter of the sleeve pipe, corresponding to the concave groove;

(2) unlocking working position: when the inner part of the annular spring element 2 and outer part of the outer pipe element 6 are interfered, the spring element is softened, and the plug is divorced from the concave groove; the distance of the two plugs of the spring element is more than the outer diameter of the sleeve pipe, corresponding to the concave groove, and less than the outer diameter of the outer pipe element, corresponding to the through holes.

In above technical solution, a waist structure is provided on said spring element 2, which forces the plug divorcing from the concave groove when the inner part of the annular spring element 2 and outer part of the outer pipe element 6 are interfered and the spring element is softened, and which forces the spring element into the position of said unlocking working position.

At least one protuberant block 7 is provided on the inner wall of said sleeve pipe, and a coordinate groove is provided on the outer wall of the inner pipe element; a cap 8 is provided on the top end of the inner pipe element, and said sleeve pipe 1 is provided fixedly around the inner pipe element 3 by the cap 8.

Said protuberant block and the coordinate groove prevent relative rotation between the sleeve pipe and inner pipe element, and the sleeve pipe is provided fixedly around the inner pipe element by the cap and prevents axial displacement of the sleeve pipe and inner pipe element, so such structure together forces the sleeve pipe fixing around the up end of the inner pipe element. And at the same time, such structure can provide an impact press to the bowl bearing of the bicycle head.

Said sleeve pipe 1 is consisted of an upper taper piece 9 [symbol] sleeve 10 and lower tapper piece 11, a coordinate taper is provided on the end of said outer pipe element. An outside sleeve 12 is provided around said spring element 2. A connector 13 is provided which connects with the spring element 2 in one end, and connects with a prizing piece 14 in the other end, said prizing piece 14 connects rotary with a C-shaped ring 15 which is fixed between the inner pipe element and outer pipe element.

The prizing piece is easy to use by women and children. And It's easy to disassemble the inner pipe element and outer pipe element; the connector and C-shape ring are used to connect the inner pipe element and outer pipe element, and prevent lost when the two pipes are disassembled.

In above technical solution, two concave grooves are provide on the side wall of the sleeve pipe 1, two plugs 5 of said spring element 2 drill through the through hole and clamp in the concave grooves respectively. The two concave grooves of said two concave grooves 1 are cuneal, and the corresponding plugs 5 of the spring element are coordinate cuneal plugs.

The working principle of the present invention is as follows: When assembling, the sleeve pipe is provided fixedly around the up end of the inner pipe element first, then both the inner pipe element and the sleeve pipe are inserted in the outer pipe element, the two pipes are fixed by the spring element. This time the spring element is in the locking working position. When disassembling, the spring element is pulling up and clamps on the outer pipe element, the two plugs open outwards and divorce from the holes, and then the outer pipe element can be pulled out. This time the spring element is in the unlocking working position.

### EXAMPLE 2

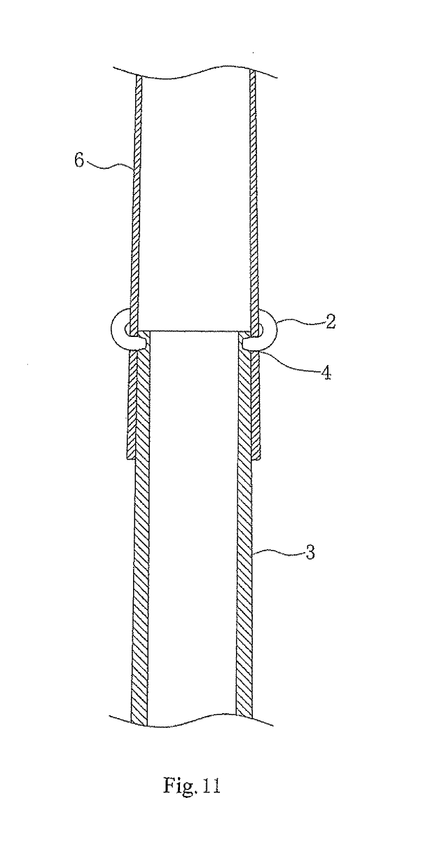

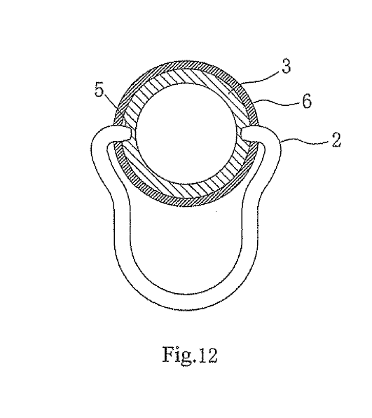

FIG. 11˜12 illustrate a pipe element fast connection structure, in which an inner pipe element is inserted in an outer pipe element and two pipe elements are fixed each other by a connector element, said connector element comprises an annular spring element 2 with an open end, and the open end of the spring element 2 bends inward and forms a pair of plugs 5;

a pair of through holes 4 are provided on said outer pipe element 6, and two holes are provided on the inner pipe element 3 which is inserted in the outer pipe element, corresponding to said through holes 4;

a pair of plugs 5 of said spring element 2 plug into a pair of through holes 4 of said outer pipe element 6, and when the spring element 2 is turned around the through holes 4 of the outer pipe element 6, at least two steady state which form two working positions can be formed:

(1) locking working position: two plugs 5 of said spring element 2 drill through the through hole of said outer pipe element and clamp in the hole of the inner pipe element; the distance of the two plugs of the spring element is less than the outer diameter of the inner pipe element, corresponding to the hole;

(2) unlocking working position: when the inner part of the annular spring element 2 and outer part of the outer pipe element 6 are interfered, the spring element is softened, and the plug is divorced from the hole; the distance of the two plugs of the spring element is more than the outer diameter of the inner pipe element, corresponding to the hole, and less than the outer diameter of the outer pipe element, corresponding to the through holes.

A waist structure is provided on said spring element 2, which forces the plug divorcing from the concave groove when the inner part of the annular spring element 2 and outer part of the outer pipe element 6 are interfered and the spring element is softened, and which forces the spring element into the position of said unlocking working position.

1. A pipe element fast connection structure, in which an inner pipe element is inserted in an outer pipe element and two pipe elements are fixed each other by a connector element, wherein:
said connector element comprises an annular spring element with an open end, and the open end of the spring element bends inward and forms a pair of plugs; a pair of through holes are provided on said outer pipe element, and at least one hole is provided on the inner pipe element which is inserted in the outer pipe element, corresponding to said through holes; a pair of plugs of said spring element plug into a pair of through holes of said outer pipe element, and when the spring element is turned around the through holes of the outer pipe element, at least two steady state which form two working positions can be formed:
(1) locking working position: at least one plug of said spring element drill through the through hole of said outer pipe element and clamp in the hole of the inner pipe element; the distance of the two plugs of the spring element is less than the outer diameter of the inner pipe element, corresponding to the hole;
(2) unlocking working position: when the inner part of the annular spring element and outer part of the outer pipe element are interfered, the spring element is softened, and the plug is divorced from the hole; the distance of the two plugs of the spring element is more than the outer diameter of the inner pipe element, corresponding to the hole, and less than the outer diameter of the outer pipe element, corresponding to the through holes.

2. A pipe element fast connection structure, in which an inner pipe element is inserted in an outer pipe element and two pipe elements are fixed each other by a connector element, wherein:
said connection element comprises a sleeve pipe and an annular spring element with an open end, and the open end of the spring element bends inward and forms a pair of plugs, said sleeve pipe is provided fixedly around the up end of the inner pipe element, and both the inner pipe element and the sleeve pipe are inserted in the outer pipe element;
a pair of through holes are provided on the outer pipe element, and at least one concave groove is provided on the side wall of the sleeve pipe, corresponding to the through holes;
a pair of plugs of said spring element plug into a pair of through holes of said outer pipe element, and when the spring element is turned around the through holes of the outer pipe element, at least two steady state which form two working positions can be formed:
(1) locking working position: at least one plug of said spring element drill through the through hole of said outer pipe element and clamp in the concave groove of the sleeve pipe; the distance of the two plugs of the spring element is less than the outer diameter of the sleeve pipe, corresponding to the concave groove;
(2) unlocking working position: when the inner part of the annular spring element and outer part of the outer pipe element are interfered, the spring element is softened, and the plug is divorced from the concave groove; the distance of the two plugs of the spring element is more than the outer diameter of the sleeve pipe, corresponding to the concave groove, and less than the outer diameter of the outer pipe element, corresponding to the through holes.

3. The pipe element fast connection structure as set forth in claim 2, wherein a waist structure is provided on said spring element, which forces the plug divorcing from the concave groove when the inner part of the annular spring element and outer part of the outer pipe element are interfered and the spring element is softened, and which forces the spring element into the position of said unlocking working position.

4. The pipe element fast connection structure as set forth in claim 2, wherein a plastic ball is provided on said spring element or the outer pipe element, which forms a block point, forcing the plug divorcing from the concave groove when the inner part of the annular spring element and outer part of the outer pipe element are interfered and the spring element is softened, and forcing the spring element into the position of said unlocking working position.

5. The pipe element fast connection structure as set forth in claim 2, wherein at least one protuberant block is provided on the inner wall of said sleeve pipe, and a coordinate groove is provided on the outer wall of the inner pipe element; a cap is provided on the top end of the inner pipe element, and said sleeve pipe is provided fixedly around the inner pipe element by the cap.

6. The pipe element fast connection structure as set forth in claim 2, wherein said sleeve pipe is consisted of an upper taper piece, sleeve and lower tapper piece, a coordinate taper is provided on the end of said outer pipe element.

7. The pipe element fast connection structure as set forth in claim 2, wherein an outside sleeve is provided around said spring element.

8. The pipe element fast connection structure as set forth in claim 2, wherein a connector is provided which connects with the spring element in one end, and connects with a prizing piece in the other end, said prizing piece connects rotary with a C-shaped ring which is fixed between the inner pipe element and outer pipe element.

9. The pipe element fast connection structure as set forth in claim 2, wherein two concave grooves are provide on the side wall of the sleeve pipe, two plugs of said spring element drill through the through hole and clamp in the concave grooves respectively.

10. The pipe element fast connection structure as set forth in claim 9, wherein at least one concave groove of said two concave grooves is cuneal, and the corresponding plug of the spring element is coordinate cuneal plug.
